(19) United States
(12) Patent Application Publication
(10) Pub. No.: US 2014/0362853 A1
(43) Pub. Date: Dec. 11, 2014

(54) LAYER-2 MULTICAST-BASED PACKET FORWARDING METHOD FOR PASSIVE OPTICAL NETWORK

(71) Applicant: National Chung Cheng University, Chia-yi County (TW)

(72) Inventors: Cheng-Shong Wu, Minxiong Township (TW); Hui-Kai Su, Da-Lin (TW)

(21) Appl. No.: 13/915,019

(22) Filed: Jun. 11, 2013

(51) Int. Cl. H04L 12/741; H04L 12/18

(52) U.S. Cl. CPC H04L 45/74; H04L 12/18
USPC 370/390

(57) ABSTRACT

A layer-2 multicast-based packet forwarding method for PUN includes the following steps of A) disposing a downlink L2-header modifier between a router and a switch hub or a hub and disposing an uplink L2-header modifier in an ONU; B) filtering and fetching a to-be-sniffed packet by means of the uplink L2-header modifier or the downlink. L2-header modifier, the to-be-sniffed packet haying an MAC address; C) modifying the destination MAC address of the to-be-sniffed packet to a specific layer-2 multicast address by means of the uplink or downlink L2-header modifier; and D) either transmitting the to-be-sniffed packet haying a specific layer-2 multicast address to the router or a protocol analyzer by means of the uplink or downlink. L2-header modifier or transmitting the to-be-sniffed packet having a specific layer-2 multicast address to the ONU or the protocol analyzer.

### BACKGROUND OF THE INVENTION

1. Field of the Invention

The present invention relates generally to the optical communication network technology and more particularly, to a layer-2 multicast-based packet forwarding method for passive optical network (PON).

2. Description of the Related Art

As the optical communication network technology makes progress, the PON has become the primary technique of next generation access network, providing ultrahigh speed and stable network access service. However, as the network transmission rate is increased, many problems about network management and network security are derived therefrom, e.g. network packet sniffing becomes more difficult, or the existing equipments fail to track, record, and analyze the packets in time.

Taking a gigabit passive optical network (GPON) 90 as an example, as shown in FIG. 4, it is formed of an optical line terminal (OLT) 91, an optical network unit (ONU) 93, and a passive optical splitter (POS) 95. Since the data exchange between the OLT 91 and the ONU 93 is protected by key encryption, so it is generally impossible to sniff and monitor the full packets of the POS.

U.S. Pat. No. 7,450,551 disclosed a multicast transmission method in GPON. U.S. Pat. Nos. 7,639,905 and 7,904,581 disclosed fast channel change methods for application of PON network multicast streaming. However, each of the three prior patents encounters the sniffing difficulty and fails to record and analyze in time.

### SUMMARY OF THE INVENTION

The primary objective of the present invention is to provide a layer-2 multicast-based packet forwarding method, which can sniff packet forwarding status under layer-2 multicast architecture and complete operation of forwarding normal packet to the destination node without resulting in need for additional GPON bandwidth.

The secondary objective of the present invention is to provide a layer-2 multicast-based packet forwarding method, which can forward a to-be-sniffed packet to a specific node via layer-2 multicast to further sniff the packet for follow-up tracking, recording, and analysis.

The foregoing objectives of the present invention are attained by the layer-2 multicast-based packet forwarding method including the following steps of A) disposing a downlink L2-header modifier between a router and a switch hub or a hub for modifying packets between the router and the switch hub or the hub and disposing an uplink L2-header modifier in each of ONUs of a PON for modifying the packet of the corresponding ONU; B) filtering and fetching a packet by means of the uplink L2-header modifier or the downlink L2-header modifier to fetch a sniffed packet when the packet enters through an ONU or the router, the sniffed packet having a destination media access control (MAC) address; C) modifying the destination MAC address of the to-be-sniffed packet to a specific layer-2 multicast address by means of the uplink or downlink L2-header modifier; and D) either transmitting the sniffed packet having a specific layer-2 multicast address to an OLT through a splitter by means of the uplink or downlink L2-header modifier and then to the switch hub or the hub and further to the router, and a protocol analyzer, or transmitting the to-be-sniffed packet having a specific layer-2 multicast address to the switch hub or the hub and then to the protocol analyzer and the OLT and further to the corresponding one of the ONUs via the splitter.

Preferably, the uplink L2-header modifier, the downlink L2-header modifier, the protocol analyzer, and the router are based on interne group management protocol (IGMP) to be added into the layer-2 multicast address to receive the to-be-sniffed. packet transmitted from the uplink or downlink L2-header modifier.

Preferably, each of the ONUs includes an uplink entrance and the uplink L2-header modifier is disposed to the uplink entrance.

### BRIEF DESCRIPTION OF THE DRAWINGS

FIG. 1 is a block diagram of a preferred embodiment of the present invention.

FIG. 2 is a schematic view of the preferred embodiment of the present invention, illustrating the framework of a fetched sniffed packet.

FIG. 3 is similar to FIG. 1, illustrating the operation of the present invention.

FIG. 4 is a block diagram of conventional GPON.

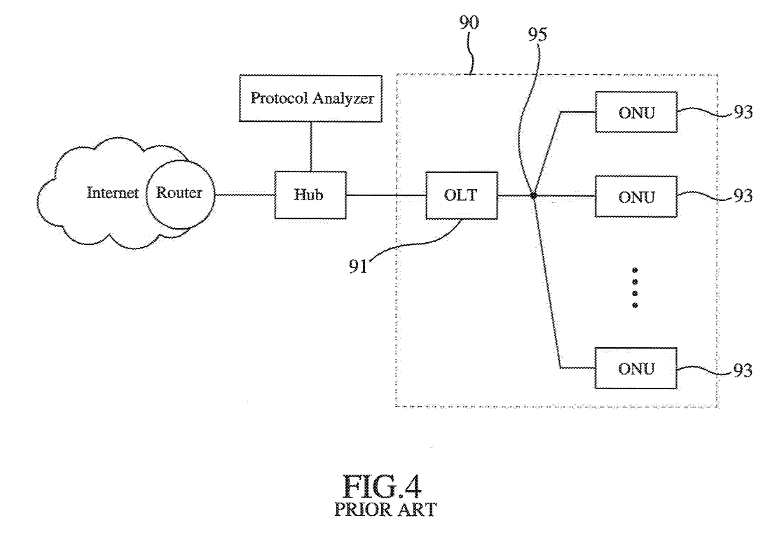

### DETAILED DESCRIPTION OF PREFERRED EMBODIMENTS

Structural features and desired effects of the present invention will become more fully understood by reference to a preferred embodiments given hereunder. However, it is to be understood that the embodiment is given by way of illustration only, thus are not limitative of the claim scope of the present invention.

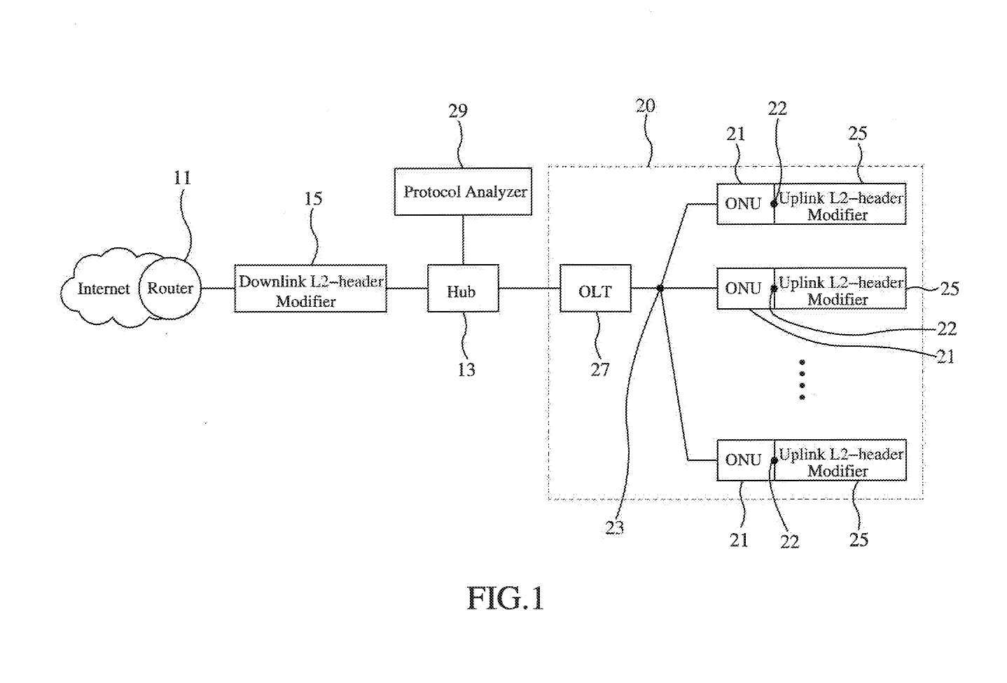

Referring to FIG. 1, a layer-2 multicast-based packet forwarding method for PON in accordance with a preferred embodiment of the present invention includes the following steps.

A) Dispose a downlink L2-header modifier 15 between a router 11 and a switch hub or a hub 13, In this way, the downlink L2-header modifier 15 is electrically connected with the router 11 and the switch hub or the hub 13 and can modify the packet between the router 11 and the switch hub or the hub 13. Dispose an uplink L2-header modifier 25 in each of ONUs 21 of a GPON 20. In this way, the uplink L2-header modifier 25 is electrically connected with one of the ON 21 and can modify the packet of the corresponding ONU 21. In this embodiment, each of the ONUs 21 includes an uplink entrance 22 and each of the uplink L2-header modifiers 25 is disposed to the uplink entrance 22 of the corresponding ONU 21.

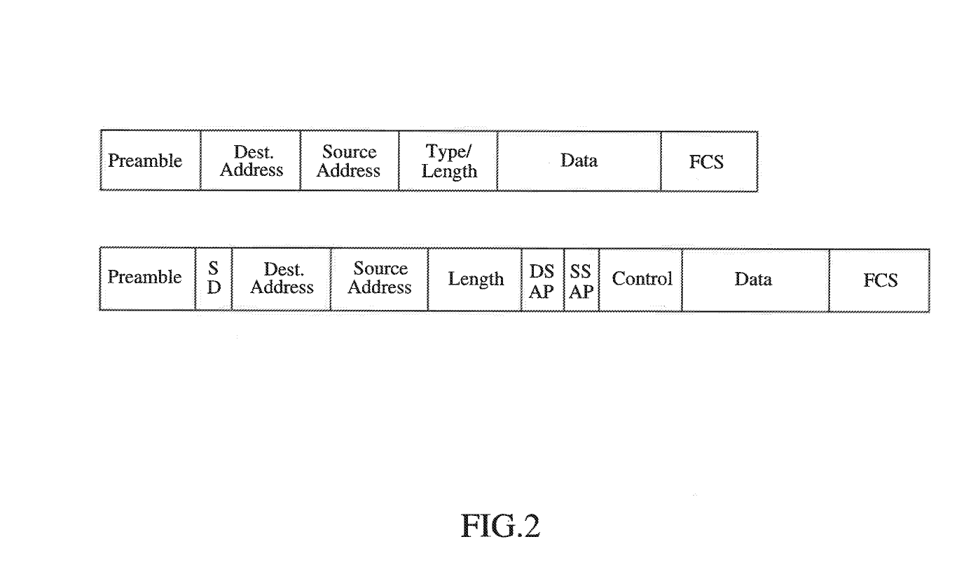

B) When a packet enters through one of the ONUs 21 or the router 11, filter and fetch the packet by means of the uplink L2-header modifier 25 or the downlink L2-header modifier 15 to further fetch a to-be-sniffed packet containing a destination MAC address. When it is intended to fetch the to-be-sniffed packet, it can proceed based on the prior art, e.g. comparing destination MAC address, source MAC address, destination Internet protocol (IP) address, source IP address, protocol identity (ID), transmission control protocol (TCP)/user datagram protocol (UDP) destination port, and TCP/UDP source port for filtering and fetching the to-be-sniffed packet. FIG. 2 illustrates the architecture of the fetched to-be-sniffed packet which is the header information of conventional Ethernet, i.e. Ethernet V2 and Institute of Electrical and Electronics Engineers (IEEE) 802.3 where Dest. Address is the destination address and Source Address is the source address.

C) Modify the destination MAC address of the to-be-sniffed packet to a specific layer-2 multicast address by means of the uplink L2-header modifier 25 or the downlink L2-header modifier 15.

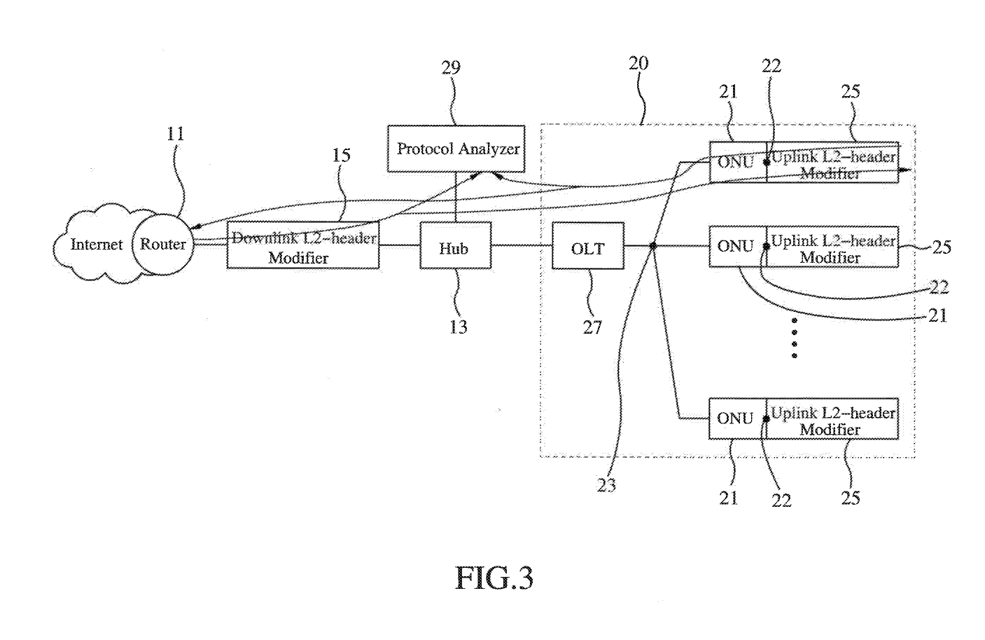

D) Either transmit the to-be-sniffed packet having a specific layer-2 multicast address to an OLT 27 through a splitter 23 by means of the uplink L2-header modifier 25 and then to the switch huh or the hub 13 and further to the router 11 and a protocol analyzer 29, or transmit the to-be-sniffed packet having the specific layer-2 multicast address to the switch hub or the hub 13 and then to the protocol analyzer 29 and the OLT 27 and further to the corresponding one of the ONUs 21 via the splitter 23, as shown in FIG. 3, for follow-up tracking, recording, or analysis.

The uplink L2-header modifier 25, the downlink L2-header modifier 15, the protocol analyzer 29, and the router 11 are based on the IGMP to be added into the specific layer-2 multicast address to receive the to-be-sniffed packet transmitted by the uplink L2-header modifier 25 or the downlink L2-header modifier 15.

In light of the steps mentioned above, the uplink L2-header modifier 25 or the downlink L2-header modifier 15 can fetch the packet to acquire the to-be-sniffed packet and then the to-be-sniffed packet can be forwarded to a specific node (e.g. the protocol analyzer 29 or the router 11) by the layer-2 multicast. In this way, without any need for additional bandwidth of the GPON 20 and without any adverse effect on the normal packet exchange, the protocol analyzer 29 can receive the to-be-sniffed packet and none of any application software or service will be affected, so forwarding the to-be-sniffed packet can be completed to achieve the purpose of packet sniffing.

In addition, the downlink L2-header modifier 15 is disposed between the router 11 and the switch hub or the hub 13 and the uplink L2-header modifier 25 is disposed to the ONUs 21, so the basic architecture of the existing GPON is not changed. In light of this, the present invention can be applied to the existing equipment having the GPON 20 or the router 11 or to an independent product integrated with the uplink L2-header modifier 25 and the downlink L2-header modifier 15.

It is worth mentioning that the present invention is applicable at all no matter whether the PON supports the multicast or not. As far as the PON supporting the multicast is concerned, the transmission effect of the multicast frame can be enhanced. As far as the PON which does not support the multicast, the PON can transmit the multicast frame via broadcast to be normally operational.

In conclusion, the present invention can reach the following effects.

1. The packet forwarding is sniffed by the layer-2 multicast, so the normal packet can be successfully forwarded to the destination node without leading to any need for additional PON bandwidth.

2. The to-be-sniffed packet can be forwarded to the destination node via the layer-2 multicast to be further sniffed for follow-up tracking, recording, and analysis.

What is claimed is:

1. A layer-2 multicast-based packet forwarding method for passive optical network (PON), comprising steps of:
A) Disposing a downlink L2-header modifier between a router and a switch hub or a hub for modifying a packet between the router and the switch hub or the hub and disposing an uplink L2-header modifier in each of optical network units (ONUs) of a PON for modifying the packet of the corresponding ONU;
B) filtering and fetching a packet by means of the uplink L2-header modifier or the downlink L2-header modifier to fetch a to-be-sniffed packet when the packet enters through an ONU or the router, the to-be-sniffed packet having a destination media access control (MAC) address;
C) modifying the destination MAC address of the to-be-sniffed packet to a specific layer-2 multicast address by means of the uplink or downlink L2-header modifier; and
D) either transmitting the to-be-sniffed packet having specific layer-2 multicast address to an optical line terminal (OLT) through a splitter by means of the uplink L2-header modifier and then to the switch hub or the hub and further to the router and a protocol analyzer, or transmitting the to-be-sniffed packet having a specific layer-2 multicast address to the switch hub or the hub and then to the protocol analyzer and the OLT and further to the corresponding one of the ONUs via the splitter.

2. The layer-2 multicast-based packet forwarding method as defined in claim 1, wherein the uplink L2-header modifier, the downlink L2-header modifier, the protocol analyzer, and the router a based on internet group management protocol (IGMP) to be added into the specific layer-2 multicast address for receiving the to-be-sniffed packet transmitted from the uplink or downlink L2-header modifier.

3. The layer-2 multicast-based packet forwarding method as defined in claim 1, wherein each of the ONUs comprises an uplink entrance, the uplink L2-header modifier being disposed to the uplink entrance.
